(19) United States
(12) Patent Application Publication
(10) Pub. No.: US 2025/0119252 A1
(43) Pub. Date: Apr. 10, 2025

(54) METHOD OF SOUNDING REFERENCE SIGNAL TRANSMISSION, COMMUNICATION METHOD AND SYSTEM, AND COMPUTER-READABLE MEDIUM

(71) Applicant: Samsung Electronics Co., Ltd., Suwon-si (KR)

(72) Inventors: Alexei Vladimirovich DAVYDOV, Nizhny Novgorod (RU); Gregory Vladimirovich MOROZOV, Nizhny Novgorod (RU); Dmitry Sergeyevich DIKAREV, Nizhny Novgorod (RU); Gregory Aleksandrovich ERMOLAEV, Nizhny Novgorod (RU); Vladimir Alexandrovich PESTRETSOV, Nizhny Novgorod (RU); Denis Viktorovich ESIUNIN, Nizhny Novgorod (RU); Maksim Viktorovich ESIUNIN, Nizhny Novgorod (RU)

(21) Appl. No.: 18/909,769

(22) Filed: Oct. 8, 2024

(30) Foreign Application Priority Data
Oct. 10, 2023 (RU) 2023125909

(51) Int. Cl. H04L 5/00; H04J 13/00

(52) U.S. Cl. CPC H04L 5/0048; H04J 13/0062; H04L 5/0007

(57) ABSTRACT

The disclosure relates to a 5G or 6G communication system for supporting a higher data transmission rate. The present disclosure relates to wireless communication and, more specifically, to a method of sounding reference signal transmission. The technical result consists in reducing the processing complexity for SRS generation and transmission at the base station, increasing the interference immunity of SRS transmission, and enabling dynamic switching between different SRS sequence configurations. A method of sounding reference signal (SRS) transmission from the user equipment (UE) to the base station (BS) comprises: configuring, at the base station, transmission comb-specific SRS sequences; indicating SRS transmission from the user equipment in accordance with said configuration; generating, in the user equipment, an SRS using at least one said transmission comb-specific SRS sequence, and transmitting the SRS from the user equipment to the base station.

### CROSS-REFERENCE TO RELATED APPLICATION

This application is based on and claims priority under 35 U.S.C. § 119 to Russian Patent Application No. 2023125909, filed Oct. 10, 2023. in the Russian Intellectual Property Office, the disclosure of which is incorporated by reference herein in its entirety.

### BACKGROUND

### 1. Field

The present disclosure relates to wireless communication and, more specifically, to a method of sounding reference signal transmission.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 sec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mecahnisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### SUMMARY

The present disclosure is intended to overcome at least some of the above problems.

One aspect of the present disclosure provides a method of sounding reference signal (SRS) transmission from a user equipment (UE) to a base station (BS), comprising:
configuring, by the base station, transmission comb-specific SRS sequences on the user equipment side;
indicating SRS transmission from the user equipment in accordance with said configuration; and/or
generating, in the user equipment, an SRS using at least one said transmission comb-specific SRS sequence, and transmitting the SRS from the user equipment to the base station.

According to one embodiment of the method, said configuring of transmission comb-specific SRS sequence at the base station comprises configuring SRS transmission parameters including number of SRS ports, SRS transmission comb indexes, and one or more sets of parameters n_{ID}^{λ}^{ₚ}^{,SRS} specific for each transmission comb.

According to an embodiment, said indicating of SRS transmission from the user equipment in accordance with said configuration comprises requesting, by the base station, the UE to transmit the SRS using one set of parameters n_{ID}^{λ}^{ₚ}^{,SRS}, where n_{ID}^{λ}^{ₚ}^{,SRS} value is different for each transmission comb.

According to an embodiment, SRS sequence is generated in the user equipment in accordance with the expression:

$$\overline{r} \text{?} ( n ) = {x}_{q} ( n mod {N}_{ZC} ) ,$$

$$where$$

$${x}_{q} ( m ) = {e}^{- j \frac{\text{?}}{{N}_{ZC}}} ,$$

$$q = ⌊ \overline{q} + 1 / 2 ⌋ + {v}_{p} \cdot {( - 1 )}^{⌊ 2 \overline{q} ⌋} , and$$

$$\overline{q} = {N}_{ZC} \cdot ( {u}_{p} + 1 ) / 31 ,$$

$$\text{?} \text{indicates text missing or illegible when filed}$$

where (A mod B) is the operation of taking the remainder of dividing A by B, x_{q}(m) is the Zadoff-Chu (ZC) sequence, N_{ZC} is the ZC-sequence length, q is the root of ZC-sequence, q̅ is an intermediate variable, m is the ZC-sequence element index, └ ┘ is the operation of rounding a fractional number to the nearest integer that is less than or equal to the original one, n is the running index along the length of SRS sequence, uₚ is the sequence group index for P-th antenna port, vₚ is the base sequence index for p-th antenna port.

According to an embodiment, the sequence group index is calculated by:

$${u}_{p} = ( {f}_{gh} ( {n}_{s} , l ) + {n}_{ID}^{{λ}_{p} , SRS} ) mod 30 ,$$

where f_{gh}(nₛ,l) is the pseudo-random sequence that depends on the slot index nₛ and the OFDM symbol index l in the slot, (A mod B) is the operation of taking the remainder of dividing A by B, n_{ID}^{λ}^{ₚ}^{,SRS} is transmission comb-specific parameter set for each SRS transmission comb offset λₚ, and

$${λ}_{p} = 0 , 1 , … {K}_{TC} - 1 ,$$

where K_{TC} is the number of SRS transmission combs.

In an embodiment, the set of comb-specific parameters n_{ID}^{λ}^{ₚ}^{,SRS}∈{0, 1, . . . , 1023} is configured by radio resource control (RRC) protocol for each SRS transmission comb offset λₚ.

In an embodiment, the set of comb-specific parameters n_{ID}^{λ}^{ₚ}^{,SRS} it is obtained in accordance with the expression:

$${n}_{ID}^{{λ}_{p} , SRS} = {n}_{ID}^{SRS} + {λ}_{p} ,$$

where n_{ID}^{SRS}∈{0, 1, . . . , 1023} is configured by RRC.

In an embodiment, if SRS sequence group hopping is enabled in the user equipment:

$${f}_{gh} ( {n}_{s} , l ) = {\sum }_{i = 0}^{7} c ( 8 ( {n}_{s} {N}_{symb}^{slot} + l ) + i ) {2}^{′} mod 30 ,$$

where nₛ is the slot index, l is the OFDM symbol index in the slot, N_{symb}^{slot} is the number of symbols in the slot, c(·) is a pseudo-random binary sequence initialized with cᵢₙᵢₜ=n_{ID}^{λ}^{ₚ}^{,SRS} or cᵢₙᵢₜ=n_{ID}^{SRS}, i is the binary digit-responsible summation index, (A mod B) is the operation of taking the remainder of dividing A by B.

According to an embodiment, if base sequence hopping is not enabled in the user equipment, the base sequence index vₚ is determined in accordance with the expression:

vₚ=λₚ mod 2,

where λₚ is the SRS transmission comb offset, and λₚ=0, 1, . . . K_{TC}−1.

According to an embodiment, if base sequence hopping is enabled in the user equipment, the base sequence index vₚ is determined according to the expression:

$${ν}_{p} = ( c ( {n}_{s} {N}_{symb}^{slot} + l ) + {λ}_{p} ) mod 2 ,$$

where λₚ is the SRS transmission comb offset, and λₚ=0, 1, . . . K_{TC}−1, and c(·) is a pseudo-random binary sequence initialized with cᵢₙᵢₜ=n_{ID}^{SRS}.

According to an embodiment, transmission comb-specific SRS sequence is determined by multiple radio resource control (RRC) protocol parameters independently configured for each transmission comb.

According to an embodiment, transmission comb-specific SRS sequence is determined by single SRS parameter and transmission comb offset.

According to an embodiment, the transmission comb-specific SRS sequence corresponds to sequence group.

According to an embodiment, the transmission comb-specific SRS sequence corresponds to base sequence.

According to an embodiment, the comb-specific SRS sequence depends on the OFDM symbol index in the slot.

According to an embodiment, the comb-specific SRS sequence depends on the slot index.

According to an embodiment, the actual sequence group index is determined from RRC configuration parameter and pseudo-random sequence.

According to an embodiment, initialization of a pseudo-random sequence is common to all SRS transmission combs.

According to an embodiment, initialization of a pseudo-random sequence is different for all SRS transmission combs.

According to an embodiment, multiple comb-specific transmission parameters are configured by RRC, and the actual set of parameters is indicated by downlink control information (DCI).

According to an embodiment, one set of parameters corresponds to parameters common to all combs.

One more aspect of the present disclosure provides a method of communication between a user equipment (UE) and a base station (BS), comprising:
transmitting sounding reference signal (SRS) from the user equipment to the base station;
measuring the SRS by the base station and selecting a precoder for the user equipment;
transmitting, from the base station to the user equipment, uplink grant with indication of the selected precoder; and/or
transmitting signal from the user equipment to the base station using the selected precoder.

Still one more aspect of the present disclosure provides a communication system comprising at least one user equipment (UE) and at least one base station (BS), wherein the at least one base station is designed to configure transmission comb-specific SRS sequences on the user equipment side and transmit to the user equipment information indicating the SRS transmission from the user equipment in accordance with said configuration; the at least one user equipment is designed to receive from the base station the information containing the SRS transmission indication, generate an SRS using said at least one transmission comb-specific SRS sequence, and transmit the SRS to the base station.

In one embodiment, the communication system is designed to perform steps of the method of communication.

One more aspect of the present disclosure provides a computer-readable medium comprising a program which, when executed by at least one processor, causes said at least one processor to perform the method of SRS transmission.

The present disclosure provides lower complexity processing at the base station for SRS generation and transmission, improves interference immunity of SRS transmission, and provides dynamic switching between different SRS sequence configurations.

### BRIEF DESCRIPTION OF THE DRAWINGS

The disclosure is further explained by a description of preferred embodiments of the disclosure with references to accompanying drawings, in which:

FIG. 1 illustrates an example of conventional transmission combs according to various embodiments of the present disclosure;

FIG. 2 illustrates an example of a flow diagram of a for an SRS transmission according to various embodiments of the present disclosure;

FIG. 3 illustrates an example of conventional transmission combs (left) and transmission combs with ZC sequences according to various embodiments of the present disclosure;

FIG. 4 illustrates a user equipment (UE) according to various embodiments of the present disclosure; and

FIG. 5 illustrates a base station (BS) according to various embodiments of the present disclosure.

### DETAILED DESCRIPTION

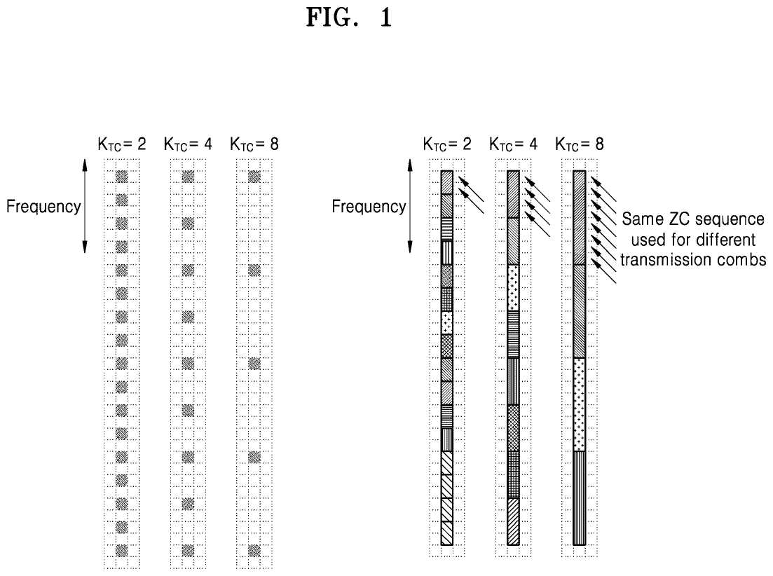

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

Sounding reference signal (SRS) is a reference signal in 4^{th} generation (4G) and 5^{th} generation (5G) communication networks transmitted by a user equipment (UE) to a base station (BS). In said communication networks, sounding reference signal can be used for various purposes including, but not limited to:
calculation of reciprocity-based downlink precoding (precoder);
selection of codebook and non-codebook uplink precoding;
measurements for uplink-based positioning;
calculation of timing advance (TA); and/or
analog beam management, etc.

Therefore, based on measurement results of received sounding reference signal, the base station performs resource planning and selects required uplink data transmission parameters, for example, frequency-time resources, pre-coding, modulation, etc.

Sounding reference signal is decoupled from other physical channels and can be transmitted by the user equipment on demand according to the configuration provided by the serving base station.

In accordance with TS 38.211, when SRS is transmitted on a given resource, the sequence r^{(p)}(k′,l′) for each orthogonal frequency division multiplexing (OFDM) symbol l′ and for each antenna port p of the SRS resource may be multiplied with the amplitude scaling factor β_{SRS} according to the required transmit power. Sounding reference signal α_{k,l}^{(p)} transmitted on resource elements (k, l) in a slot for each antenna port p is defined as:

$${α}_{{K}_{TC} {k}^{′} + {k}_{0}^{( p )} , {l}^{′} + {l}_{0}}^{( p )} = \{ \begin{matrix}\frac{1}{\sqrt{{N}_{ap}}} {β}_{SRS} {r}^{( p )} ( {k}^{′} , {l}^{′} ) & {k}^{′} = 0 , 1 , … , {M}_{sc , b}^{SRS} - 1 & {l}^{′} = 0 , 1 , … , {N}_{symb}^{SRS} - 1 \\ 0 & otherwise & \end{matrix} \} \qquad ( 1 )$$

where K_{rc}∈{2, 4, 8} is the number of SRS transmission combs, l′ is the SRS symbol number, k′ is the SRS subcarrier number, β_{SRS} is the amplitude scaling factor, M_{sc,b}^{SRS} is the length of SRS sequence, N_{symb}^{SRS} is the number of OFDM symbols of the SRS resource, Nₐₚ is the total number of user's SRS ports, k₀^{(p)} is the frequency shift of SRS port p, l₀ is the time shift of the SRS signal in the slot.

SRS sequence for the SRS resource is generated according to the expression:

$${r}^{( p )} ( n , {l}^{′} ) = {r}_{u , v}^{( α , δ )} ( n ) \qquad ( 2 )$$

$$where$$

$$0 \leq n \leq {M}_{sc , b}^{SRS} - 1 ,$$

$${l}^{′} ∈ \{ 0 , 1 , … , {N}_{symb}^{SRS} - 1 \} ,$$

and
n is the running index along the length of SRS sequence.

Length of the SRS sequence is specified by the expression:

$${M}_{sc , b}^{SRS} = {m}_{SRS , b} {N}_{sc}^{RB} / ( {K}_{TC} {P}_{F} ) \qquad ( 3 )$$

where m_{SRS,b} is the number of resource blocks used for SRS transmission, N_{sc}^{RB} is the number of subcarriers per resource block (for 5G NR this variable is 12), P_{F} is the frequency scaling factor signaled by the base station.

Sequence r_{u,v}^{(α,δ)}(n) is defined by a cyclic shift a of a base sequence r̅_{u,v}⁽ⁿ⁾ according to:

$${r}_{u , v}^{( α , δ )} ( n ) = {e}^{j α n} {\overline{r}}_{u , v} ( n ) , 0 \leq n < {M}_{ZC} \qquad ( 4 )$$

where α is the parameter defining the cyclic shift in the time domain, M_{ZC}=m_{SRS,b}N_{sc}^{RB}/2^{δ} is the length of the sequence, β=log₂(K_{TC}), and j is imaginary unit.

Furthermore, multiple sequences are defined from a single base sequence through different values of α and δ.

Base sequences r̅_{u,v}(n) are divided into groups, where u∈{0, 1, . . . , 29} is the sequence group number (index), and v is the base sequence number (index) within the group, such that each group contains one base sequence (v=0) of length M_{ZC}=m_{SRS,b}N_{sc}^{RB}/2^{δ}, where ½≤m_{SRS,b}/2^{δ}≤5, and two base sequences (v=0, 1) of each length M_{ZC}=m_{SRS,b}N_{sc}^{RB}/2^{δ}, where 6≤m_{SRS,b}/2^{δ}. The definition of the base sequence r̅_{u,v}(M_{TC}−1) depends on the sequence length M_{ZC}.

For M_{ZC}≥3N_{sc}^{RB}, the base sequence r̅_{u,v}(0), . . . , r̅_{u,v}(M_{ZC}−1) is defined by the following expression:

$${\overline{r}}_{u , v} ( n ) = {x}_{q} \cdot ( n mod {N}_{ZC} ) \qquad ( 5 )$$

$$where$$

$${x}_{q} ( m ) = {e}^{- j \frac{\text{?} qm ( m + 1 )}{{N}_{ZC}}} , \qquad ( 6 )$$

$$q = ⌊ \overline{q} + 1 / 2 ⌋ + v \cdot {( - 1 )}^{⌊ 2 \overline{q} ⌋} , and \qquad ( 7 )$$

$$\overline{q} = {N}_{ZC} \cdot ( u + 1 ) / 31 \qquad ( 8 )$$

$$\text{?} \text{indicates text missing or illegible when filed}$$

where (A mod B) is the operation of taking the remainder of dividing A by B, x_{q}(m) is the Zadoff-Chu (ZC) sequence, N_{ZC} is the length of ZC sequence, q is the root of ZC sequence, q̅ is an intermediate variable, m is the ZC sequence element index, └ ┘ is the operation of rounding a fractional number to the nearest integer that is less than or equal to the original one.

Furthermore, the parameter q defines the type of ZC sequence used.

SRS can be transmitted from the user equipment using multiple cyclic shifts and multiple transmission combs.

Signal received by the base station is defined as:

$${y}_{p} ( k ) = {h}_{p} {s}_{p} ( k ) + γ \cdot {g}_{p} {t}_{p} ( k ) \qquad ( 9 )$$

where sₚ(k) is the signal for p-th antenna port of the user equipment transmitting SRS signal in channel hₚ on k-th subcarrier in the presence of interfering signal, tₚ(k) is the interfering signal from p-th antenna port of the other user equipment transmitting SRS signal to a base station in gₚ channel on k-th subcarrier, γ is the interfering signal gain. Here, symmetrical configuration of the served user and the interfering user is assumed for simplicity. It is worth noting that the signals sₚ(k) and tₚ(k) correspond to the SRS signal defined by expression (1).

Estimation of channel hₚ using filtering over nₘₐₓ subcarriers is performed as:

$${\hat{h}}_{p} = \frac{1}{{n}_{max}} {\sum }_{k = 1}^{{n}_{max}} {y}_{p} ( k ) {{s}_{p} ( k )}^{*} = {h}_{p} + γ \cdot {g}_{p} {\sum }_{k = 1}^{{n}_{max}} {t}_{p} ( k ) {{s}_{p} ( k )}^{*} \qquad ( 10 )$$

where sₚ(k)* is the complex conjugate SRS signal of p-th antenna port of the user equipment, ( )* is the complex conjugation operation, nₘₐₓ is the maximum number of subcarriers.

There are two examples for transmission precoder calculation from SRS measurements:
channel estimation with filtering (nₘₐₓ>1)→a calculation of transmission precoder; and
channel estimation without filtering (nₘₐₓ=1)→average channel covariance matrix calculation→a calculation of transmission precoder.

For xMIMO systems in future 6G networks, the user equipment may have large number of transmitting (Tx) ports (e.g., 8). In this case, the second approach (without filtering) is more preferred for defining the transmission precoder due to lower complexity of the SRS receiver.

For the existing SRS design, the same ZC sequence is used for all antenna ports in different transmission combs (i.e., “e” does not depend on port p):

$${\sum }_{k = 1}^{{n}_{max} = 1} {t}_{p} ( k ) {{s}_{p} ( k )}^{*} = e \qquad ( 11 )$$

where e is a complex number with unit amplitude |e|=1.

This is illustrated in FIG. 1 where the left side shows one of transmission combs for each of cases K_{TC}∈{2, 4, 8}, and the right side shows the same ZC sequence used for all antenna ports in different transmission combs. The ZC sequences used are shown by hatching in the elements corresponding to the transmission comb subcarriers.

Expression (11) corresponds to the second approach to calculation of transmission precoder (nₘₐₓ=1).

On substituting expression (11) into expression (10), it may be as shown below:

$${\hat{h}}_{p} = {h}_{p} + γ \cdot {g}_{p} \cdot e . \qquad ( 12 )$$

Channel estimation for all antenna ports is performed according to:

$$\hat{h} = {[ \begin{matrix}\hat{{h}_{1}} & … & \hat{{h}_{p}}\end{matrix} ]}^{T} = {[ \begin{matrix}{h}_{1} & … & {h}_{p}\end{matrix} ]}^{T} + γ \cdot e \cdot {[ \begin{matrix}{g}_{1} & … & {g}_{p}\end{matrix} ]}^{T} = h + γ \cdot e \cdot g \qquad ( 13 )$$

where h=[h₁ . . . hₚ]^{T} and g=[g₁ . . . gₚ]^{T}, [ ]^{T} is the transpose operation.

Sample covariance matrix is formed by:

$${R}_{\hat{h} \hat{h}} = h {h}^{H} + {\vert γ \vert}^{2} {\vert e \vert}^{2} \cdot {gg}^{H} + 2 Re \{ γ {e}^{*} \cdot {hg}^{H} \} \qquad ( 14 )$$

where ( )^{H} is the operation of Hermitian conjugation, Re( ) is the operation of taking the real part of the expression.

The resulting channel covariance matrix averaged over N samples

$$( \frac{1}{N} \sum 2 Re \{ γ {e}^{*} \cdot {hg}^{H} \} \to 0 for N ≫ 1 )$$

is generated according to the following expression:

$$\frac{1}{N} \sum {R}_{\hat{h} \hat{h}} \approx \frac{1}{N} \sum {hh}^{H} + {\vert γ \vert}^{2} \frac{1}{N} \sum {gg}^{H} . \qquad ( 15 )$$

For interference-limited base station scenarios (e.g., γ>1), the eigenvectors of estimated total covariance matrix may be determined by interference subspace |γ|²1/NΣgg^{H}, instead of useful signal subspace 1/NEhh^{H}. This scenario is possible when the power of useful signal from the desired user equipment and interfering signals from the user equipment causing the interference are comparable, for example, when two adjacent user equipment items are served by different base stations, and interfere with each other. This may result in incorrect precoder selected by the base station, which is not matched to the communication channel of the served user equipment.

Therefore, use of the same sequence group and base sequences in different SRS transmission combs may have negative performance in the interference limited scenarios. The uplink precoder may be wrongly selected according to interfering signal instead of the desired signal.

Thus, there is a need for a method of SRS generation and transmission, having low processing complexity at the base station, improved interference immunity, and providing dynamic switching between different SRS sequence configurations.

In accordance with one aspect of the present disclosure, a method of sounding reference signal (SRS) transmission comprises:
configuring, by a base station, multiple transmission comb-specific SRS sequences on the user equipment side;
transmitting, from the base station to the user equipment (UE), information indicating SRS transmission from the UE in accordance with said configuration; and
responsive to said indication, generating an SRS in the user equipment using at least one said transmission comb-specific SRS sequence and transmitting the SRS from the user equipment to the base station.

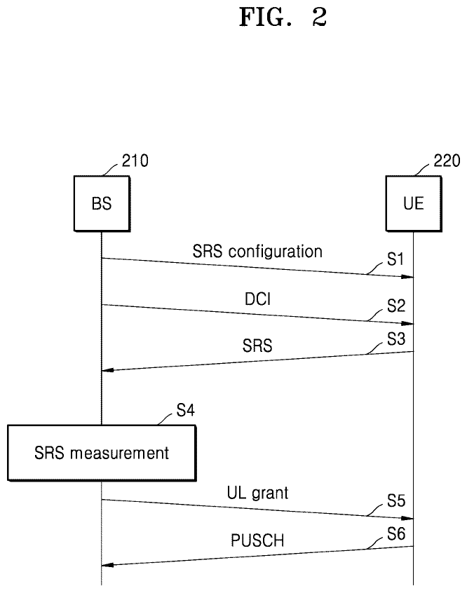

FIG. 2 an example of a flow diagram of a method for an SRS transmission according to various embodiments of the present disclosure.

In accordance with the method depicted in FIG. 2, in step S1, a base station (BS) 210 configures multiple SRS sequences specific for different transmission combs, and transmits to a user equipment (UE) 220 an SRS configuration comprising said multiple sequence configurations specific for different transmission combs. In step S2, the BS 210 transmits downlink control information (DCI) to the UE 220, initiating SRS transmission and indicating one of the previously transmitted configurations. In step S3, the UE 220 generates and transmits the SRS to the BS 210 using different SRS sequences on different transmission combs. In step S4, the BS 210 measures the SRS and selects a precoder for the UE 220 and other transmission parameters. In step S5, the BS 210 transmits uplink grant to the UE 220 with indication of the selected precoder. In step S6, the user equipment transmits signal to the BS 210 using the selected precoder on physical uplink shared channel (PUSCH).

The principle of generating an SRS in accordance with the present disclosure will be described in detail below.

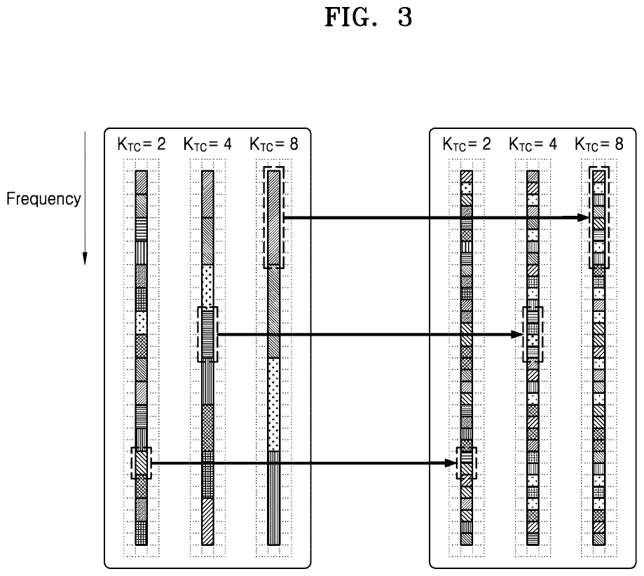

In accordance with expression (15), to eliminate the interfering signal effect, it is necessary to exclude/minimize the contribution of interfering component when the channel resulting covariance matrix is estimated. For this purpose, the method described above in accordance with the present disclosure uses different ZC sequences (with different roots) for antenna ports in different transmission combs, which is explained in more detail later with reference to FIG. 3.

Transmission comb K_{TC} is a distributed comb-shaped transmission with equally-spaced outputs over the SRS bandwidth.

FIG. 3 (left side) illustrates different conventional transmission combs for K_{TC}∈{2, 4, 8}, where the same ZC sequence is used for all antenna ports in different transmission combs. FIG. 3 (right side) illustrates transmission combs for K_{TC}∈{2, 4, 8}, where different ZC sequences (with different roots) are used in different transmission combs. The ZC sequences used are shown by hatching in the elements corresponding to transmission comb subcarriers.

Furthermore, SRS sequence group index uₚ is determined according to the expression:

$${u}_{p} = ( {f}_{gh} ( {n}_{s} , l ) + {n}_{ID}^{{λ}_{p} , SRS} ) mod 30 \qquad ( 16 )$$

where f_{gh}(nₛ, l) is a pseudo-random sequence that depends on the slot index nₛ and the OFDM symbol index l in the slot, (A mod B) is the operation of taking the remainder of dividing A by B, n_{ID}^{λ}^{ₚ}^{,SRS} is transmission comb-specific parameter set for each SRS transmission comb offset λₚ, where λₚ=0, 1, . . . K_{TC}−1.

Therefore, the transmission comb-specific SRS sequence is defined by multiple radio resource control (RRC) parameters that are independently configured for each transmission comb. The comb-specific SRS sequence corresponds to sequence group.

In an embodiment, the actual sequence group index is determined from RRC configuration parameter and pseudo-random sequence f_{gh}(nₛ, l).

Using expression (16), different sequence groups for different ports and different transmission combs can be determined.

In one embodiment, a new set of comb-specific parameters n_{ID}^{λ}^{ₚ}^{,SRS}∈{0, 1, . . . , 1023} is configured by a radio resource control (RRC) protocol for each SRS transmission comb offset λₚ, i.e., the base station determines n_{ID}^{λ}^{ₚ}^{,SRS} for each λₚ value. Here, n_{ID}^{λ}^{ₚ}^{,SRS} can take a value from the range of 0-1023. For example, for K_{TC}=4, the base station reports a set of four parameters n_{ID}^{0,SRS} n_{ID}^{1,SRS} n_{ID}^{2,SRS} n_{ID}^{3,SRS} for each transmission comb.

In an embodiment, a new set of comb-specific parameters n_{ID}^{λ}^{ₚ}^{,SRS} is obtained according to the following expression:

$${n}_{ID}^{{λ}_{p} , SRS} = {n}_{ID}^{SRS} + {λ}_{p} \qquad ( 17 )$$

where n_{ID}^{SRS}∈{0, 1, . . . , 1023} is configured by RRC. In this embodiment, the base station reports one parameter n_{ID}^{SRS} (instead of, e.g., four of the above example), and n_{ID}^{λ}^{ₚ}^{,SRS} for each comb is calculated according to said expression, i.e.;

$${n}_{ID}^{0 , SRS} = {n}_{ID}^{SRS} + 0 for the first comb ,$$

$${n}_{ID}^{1 , SRS} = {n}_{ID}^{SRS} + 1 for the second comb ,$$

$${n}_{ID}^{2 , SRS} = {n}_{ID}^{SRS} + 2 for the third comb , and$$

$${n}_{ID}^{3 , SRS} = {n}_{ID}^{SRS} + 3 for the fourth comb ,$$

Thus, the comb-specific SRS sequence is determined using a single SRS parameter and a transmission comb offset.

This embodiment is less flexible with regard to the sequence selection, but requires fewer parameters for configuration.

It is also possible to change SRS sequence groups over time.

If SRS sequence group hopping is not enabled in the time domain, then f_{gh}(nₛ,l)=0.

Otherwise, if SRS sequence group hopping is enabled, then:

$${f}_{gh} ( {n}_{s} , l ) = {\sum }_{i = 0}^{7} c ( 8 ( {n}_{s} {N}_{symb}^{slot} + l ) + i ) {2}^{i} mod 30 \qquad ( 18 )$$

where nₛ is the slot index, l is the OFDM symbol index in the slot, N_{symb}^{slot} is the number of symbols in the slot, c(·) is the pseudo-random binary sequence initialized with cᵢₙᵢₜ=n_{ID}^{λ}^{ₚ}^{,SRS} or cᵢₙᵢₜ=n_{ID}^{SRS} depending on the embodiment, i is the binary digit-responsible summation index. This expression uses eight-bit representation of the number f_{gh}(nₛ,l), where the binary digit m value is c(8(nₛN_{symb}^{slot}+1)+i).

Initialization of the pseudo-random sequence is common for all SRS transmission combs. This embodiment is preferred and uses the existing 5G specification, according to which sequence C(·) is defined in TS 38.211 specification and with initial state cᵢₙᵢₜ=n_{ID}^{SRS} (19) specified at the beginning of each frame.

In an embodiment, initialization of the pseudo-random sequence is different for all SRS transmission combs. This embodiment is suitable for general case where c(·) is defined in Section 5.2.1 of the TS 38.211 specification and with initial state cᵢₙᵢₜ=n_{ID}^{SRS}+λₚ (20) at the beginning of each frame, where λₚ is the comb index.

In an embodiment, different SRS sequence groups are determined for different SRS transmission combs. Accordingly, by using comb-specific SRS groups, interferences may be averaged, and uplink performance may be improved in the interference-limited scenarios.

The SRS base sequence index vₚ is specific for the transmission comb and is defined by:

$${v}_{p} = {λ}_{p} mod 2 \qquad ( 21 )$$

where λₚ is the SRS transmission comb offset, and λₚ=0, 1, . . . K_{TC}−1.

Meanwhile, if SRS base sequence hopping is enabled, the base sequence index vₚ is defined by:

$${v}_{p} = ( c ( {n}_{s} {N}_{symb}^{slot} + l ) + {λ}_{p} ) mod 2 \qquad ( 22 )$$

where λₚ=0, 1, . . . K_{TC}−1, and c(·) is the pseudo-random binary sequence (for example, a Gold sequence) initialized with cᵢₙᵢₜ=n_{ID}^{SRS}.

Here, the comb-specific SRS sequence corresponds to the base sequence.

In an embodiment, different SRS sequences (or base sequences) are determined for different SRS transmission combs. Accordingly, by using comb-specific SRS base sequences, interferences may be averaged, and uplink performance may be improved in the interference-limited scenarios.

Expressions (16)-(22) show that the comb-specific SRS sequence depends on the slot index and the OFDM symbol index in the slot.

On substituting the obtained values uₚ and vₚ for u and v in expressions (7) and (8), it may be as shown below the expressions:

$$q = ⌊ \overline{q} + 1 / 2 ⌋ + {v}_{p} \cdot {( - 1 )}^{⌊ 2 \overline{q} ⌋} and \qquad ( 23 )$$

$$\overline{q} = {N}_{ZC} \cdot ( {u}_{p} + 1 ) / 31. \qquad ( 24 )$$

Using expressions (23) and (24), values of the root of ZC sequence can be obtained, which depend on the p-th antenna port and the transmission comb used. Thus, a different ZC sequence may be used to generate SRS for each antenna port.

For mapping the present SRS sequence using the SRS transmission comb-specific ZC sequence, the following expression is valid:

$${\sum }_{k = 1}^{{n}_{max} = 1} {t}_{p} ( k ) {{s}_{p} ( k )}^{*} = {e}_{p} . \qquad ( 25 )$$

On substituting expression (25) into expression (10), it may be as shown below:

$${\hat{h}}_{p} = {h}_{p} + γ \cdot {g}_{p} \cdot {e}_{p} . \qquad ( 26 )$$

Channel estimation for all antenna ports is performed according to the expression:

$$\hat{h} = {\begin{matrix}[ \hat{{h}_{1}} & … & \hat{{h}_{P}} ]\end{matrix}}^{T} = {\begin{matrix}[ {h}_{1} & … & {h}_{P} ]\end{matrix}}^{T} + γ \cdot {\begin{matrix}[ {e}_{1} {g}_{1} & … & {e}_{P} {g}_{P} ]\end{matrix}}^{T} . \qquad ( 27 )$$

In this case, the sample covariance matrix is generated according to the following expression:

$${R}_{\hat{h} \hat{h}} = \hat{h} {\hat{h}}^{H} = ( {\begin{matrix}[ {h}_{1} & … & {h}_{P} ]\end{matrix}}^{T} + γ \cdot {\begin{matrix}[ {e}_{1} {g}_{1} & … & {e}_{P} {g}_{P} ]\end{matrix}}^{T} ) {( {\begin{matrix}[ {h}_{1} & … & {h}_{P} ]\end{matrix}}^{T} + γ \cdot \begin{matrix}[ {e}_{1} {g}_{1} & … & {e}_{P} {g}_{P} ]\end{matrix} )}^{*} . \qquad ( 28 )$$

The resulting channel covariance matrix averaged over N samples (e.g., physical resource block (PRB)) is generated according to the following expression:

$$\frac{1}{N} \sum {R}_{\hat{h} \hat{h}} \approx \frac{1}{N} \sum h {h}^{H} + \frac{1}{N} {\vert γ \vert}^{2} \sum {\begin{matrix}[ {e}_{1} {g}_{1} & … & {e}_{P} {g}_{P} ]\end{matrix}}^{T} {\begin{matrix}[ {e}_{1} {g}_{1} & … & {e}_{P} {g}_{P} ]\end{matrix}}^{*} \approx \frac{1}{N} \sum h {h}^{H} + I . \qquad ( 29 )$$

Due to the use of different ZC sequences in different frequency subcarrier groups (transmission combs), the parameter eₚ may have different values depending on port p. As a result, when estimating the resulting channel covariance matrix, the interference component is spatially decorrelated and degenerates into |γ|²I unit matrix.

The eigenvectors of the resultant covariance matrix may be determined by signal subspace, i.e., 1/NΣhh^{H}, due to additional randomization of SRS sequence for different ports/combs resulting into spatial whitening of the interference matrix. Therefore, the base station may be able to correctly calculate the precoder based on the SRS from the user equipment, which generally increases the interference immunity of the SRS transmission method.

To provide additional flexibility, switching between two sets of RRC pre-configured comb-specific SRS configurations {n_{ID}^{λ}^{ₚ}^{,SRS}} can be supported (see Tables 1 and 2). This embodiment provides dynamic switching between different sets of SRS configurations, one of which is the configurations defined in accordance with the present disclosure (see Table 1), and the other provides dynamic fallback to the standard SRS configuration with common ZC sequences for all transmission combs (see Table 2, “SRS transmission using common comb sequence”). Thus, the present disclosure provides an embodiment where one set corresponds to parameters common for all combs (see box “01” in Table 2 “SRS transmission using a common comb sequence”).

The actual set of comb-specific sequence parameters from the pre-configured set can be indicated to the UE using downlink control information (DCI) transmitted to the UE together with SRS triggering information.

Therefore, multiple comb-specific parameters are configured by RRC, and the actual set is indicated by downlink control information (DCI).

One DCI code-point can be used to indicate SRS transmission with common sequences for all transmission comb subcarrier bandwidths (see Table 2).

TABLE 1

| SRS triggering | |
|---|---|
| field in DCI | SRS configuration |
| 00 | No SRS |
| 01 | SRS transmission using the 1st set of comb-specific |
| | parameters |
| 10 | SRS transmission using the 2nd set of comb-specific |
| | parameters |
| 11 | SRS transmission using the 3rd set of comb-specific |
| | parameters |

TABLE 2

| SRS triggering | |
|---|---|
| field in DCI | SRS Configuration |
| 00 | No SRS |
| 01 | SRS transmission using a common comb sequence |
| 10 | SRS transmission using the 1st set of comb-specific |
| | sequence parameters |
| 11 | SRS transmission using the 2nd set of comb-specific |
| | sequence parameters |

In an embodiment, a dynamic switching between different SRS sequence configurations may be provided. For example, an SRS transmission may be triggered by DCI transmitted from a BS to a UE, and the UE may select one SRS configuration based on the received DCI, generate an SRS sequence based on the selected SRS configuration, and transmit the generated SRS sequence to the BS. In an embodiment, a dynamic fallback mode may be provided for the 5G NR SRS transmission.

An exemplary embodiment of a method of SRS generation and transmission in accordance with the present disclosure will be further disclosed.

The base station configures SRS transmission parameters including the number of SRS ports, SRS transmission comb indexes, and one or more sets of parameters n_{ID}^{λ}^{ₚ}^{,SRS} specific for each comb. Next, using DCI transmitted over PDCCH (Physical Downlink Control Channel), the base station requests the UE for SRS transmission using a single set of parameters n_{ID}^{λ}^{ₚ}^{,SRS}, where the value n_{ID}^{λ}^{ₚ}^{,SRS} can be different for each transmission comb. In response to the base station request, the user equipment generates an SRS sequence according to expressions (5), (6), (23), and (24) where the SRS sequence group index in expression (24) for each transmission comb is calculated according to expression (16), optionally using expression (17) depending on the implementation.

If the user equipment is additionally configured by RRC for SRS transmission with sequence group hopping, the sequence group is determined pseudo-randomly based on the OFDM symbol index and the slot index where the SRS transmission requested by the base station is performed, using expression (18). In this case, the pseudo-random sequence is defined in the TS 38.211 specification, with the initial state defined according to (19) or (20), depending on the implementation. Moreover, the base sequence index can be determined by expression (21) based on the index of the transmission comb used to transmit the SRS sequence.

If the user equipment is additionally configured by RRC for SRS transmission with base sequence hopping, the SRS base sequence index is determined pseudo-randomly based on the OFDM symbol index in the slot and the slot index where the SRS transmission is requested, using the expression (22).

Having generated the SRS sequence, the user equipment transmits the SRS according to the base station configuration and the selected set of parameters n_{ID}^{λ}^{ₚ}^{,SRS} on one or more frequency transmission combs on the OFDM symbols and slots allocated by the base station to the user for SRS transmission. The base station receives the SRS from the user equipment and calculates information about the channel status between the base station and the user equipment.

The above exemplary embodiment confirms that the use of different ZC sequences in different subcarrier frequency groups for SRS generation and transmission results in the interference component spatially decorrelated and degenerated into a unit matrix when calculating the resulting covariance matrix of the channel, as stated in expression (29). Therefore, the eigenvectors of the estimated resulting covariance matrix may be defined by signal subspace, i.e., 1/NΣhh^{H} due to additional randomization of SRS sequence for different SRS ports/combs, resulting into spatial whitening of the interference matrix.

It is worth noting that in other embodiments, the SRS transmission may be performed by the user equipment periodically and without DCI signaling according to the SRS transmission interval configured by the base station using RRC. In this case, a single set of parameters n_{ID}^{λ}^{ₚ}^{,SRS} is used to generate SRS sequence.

Thus, the present disclosure reduces the processing complexity at the base station for receiving SRS, enhances interference immunity of SRS transmission, and enables dynamic switching between different SRS sequence configurations. The present SRS sequence mapping method can be used for sounding and measuring channel in 6G systems with low complexity receivers.

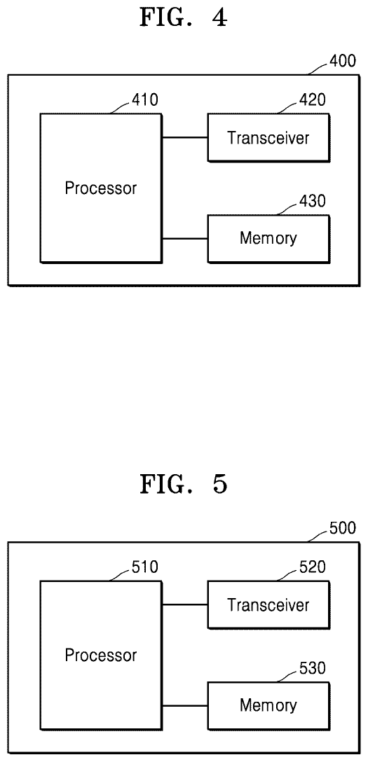

FIG. 4 illustrates a user equipment (UE) according to embodiments of the present disclosure.

Referring to the FIG. 4, the UE 400 may include a processor 410, a transceiver 420 and a memory 430. However, all of the illustrated components are not essential. The UE 400 may be implemented by more or less components than those illustrated in FIG. 4. In addition, the processor 410 and the transceiver 420 and the memory 430 may be implemented as a single chip according to an embodiment.

The aforementioned components will now be described in detail.

The processor 410 may include one or more processors or other processing devices that control the proposed function, process, and/or method. Operation of the UE 400 may be implemented by the processor 410.

The transceiver 420 may include a RF transmitter for up-converting and amplifying a transmitted signal, and a RF receiver for down-converting a frequency of a received signal. However, according to an embodiment, the transceiver 420 may be implemented by more or less components than those illustrated in components.

The transceiver 420 may be connected to the processor 410 and transmit and/or receive a signal. The signal may include control information and data. In addition, the transceiver 420 may receive the signal through a wireless channel and output the signal to the processor 410. The transceiver 420 may transmit a signal output from the processor 410 through the wireless channel.

The memory 430 may store the control information or the data included in a signal obtained by the UE 400. The memory 430 may be connected to the processor 410 and store at least one instruction or a protocol or a parameter for the proposed function, process, and/or method. The memory 430 may include read-only memory (ROM) and/or random access memory (RAM) and/or hard disk and/or CD-ROM and/or DVD and/or other storage devices.

FIG. 5 schematically illustrates a base station (BS) according to embodiments of the present disclosure.

Referring to the FIG. 5, the Base station 5000 may include a processor 510, a transceiver 520 and a memory 530. However, all of the illustrated components are not essential. The Base station 500 may be implemented by more or less components than those illustrated in FIG. 33. In addition, the processor 510 and the transceiver 520 and the memory 530 may be implemented as a single chip according to an embodiment.

The aforementioned components will now be described in detail.

The processor 510 may include one or more processors or other processing devices that control the proposed function, process, and/or method. Operation of the Base station 500 may be implemented by the processor 510.

The transceiver 520 may include a RF transmitter for up-converting and amplifying a transmitted signal, and a RF receiver for down-converting a frequency of a received signal. However, according to an embodiment, the transceiver 520 may be implemented by more or less components than those illustrated in components.

The transceiver 520 may be connected to the processor 510 and transmit and/or receive a signal. The signal may include control information and data. In addition, the transceiver 520 may receive the signal through a wireless channel and output the signal to the processor 510. The transceiver 520 may transmit a signal output from the processor 510 through the wireless channel.

The memory 530 may store the control information or the data included in a signal obtained by the Base station 500. The memory 530 may be connected to the processor 510 and store at least one instruction or a protocol or a parameter for the proposed function, process, and/or method. The memory 530 may include read-only memory (ROM) and/or random access memory (RAM) and/or hard disk and/or CD-ROM and/or DVD and/or other storage devices.

An aspect of the present disclosure provides a method of communication between the user equipment and the base station, comprising:
transmitting the sounding reference signal (SRS) from the user equipment to the base station according to the method described above;
measuring the SRS, by the base station, and selecting a precoder for the user equipment;
transmitting uplink grant with indication of the selected precoder from the base station to the user equipment; and/or
transmitting signal from the user equipment to the base station using said selected precoder.

An aspect of the present disclosure provides a communication system comprising at least one user equipment (UE) and at least one base station (BS). The at least one base station is designed to configure transmission comb-specific SRS sequences and transmit to the user equipment information containing indication of SRS transmission from the UE in accordance with the said configuration. The at least one user equipment is configured to receive information from the BS, containing the SRS transmission indication, generate the SRS using the at least one transmission comb-specific SRS sequence, and transmit the SRS to the base station.

According to an embodiment of the present disclosure, a processing of SRS signals at a base station with low complexity may be supported. Further, better interference averaging capability of SRS for interference-limited scenarios may be provided. Moreover, a dynamic switching between different SRS sequence configurations may be provided.

The communication system in one embodiment is configured to implement the communication method described above. For example, said communication system may be configured with a single and/or multi-beam analog beamforming. For example, said communication system may be configured with a massive MIMO and/or an Extreme MIMO antenna system. For example, said communication system may be configured with a time division duplex (TDD) (e.g., un-paired spectrum) and/or a frequency division duplex (FDD) (e.g., paired spectrum) mode.

An aspect of the present disclosure provides a computer-readable medium comprising a program that, when executed by at least one processor, causes at least one processor to perform the method of SRS transmission described above in accordance with the present disclosure.

Depending on the embodiment, user equipment (UE) described herein may be a terminal, a mobile station (MS), an advanced mobile station (AMS), etc. In addition, base station (BS) is a generic name for a network architecture node communicating with user equipment, such Node B (NB), eNode B (eNB), access point (AP), gNode B, etc.

The above description is applicable to a variety of wireless communication systems, including code division multiple access (CDMA), frequency division multiple access (FDMA), time division multiple access (TDMA), orthogonal frequency division multiple access (OFDMA), single carrier frequency division multiple access (SC-OFDMA), etc. OFDMA can be implemented using radio technology such as IEEE 802.11 (e.g., Wi-Fi), IEEE 802.16 (e.g., WiMAX), IEEE 802.20, E-UTRA (advanced UTRA), etc. UTRA is part of universal mobile telecommunications system (UMTS). long term Evolution (LTE) is part of evolved UMTS (E-UMTS), which uses E-UTRA. 3GPP LTE uses OFDMA in DL and SC-FDMA in UL. LTE-Advance (LTE-A) is an advanced version of 3GPP LTE. CDMA can be implemented by radio technology such as universal terrestrial access (UTRA), CDMA 2000, etc. TDMA can be implemented by radio technology such as global system for mobile communications/general purpose packet radio/enhanced data rates for GSM development (GSM/GPRS/EDGE).

Each of base station and user equipment of the present disclosure supports multiple input/multiple output (MIMO) system. Base station of the present disclosure can support both single-user MIMO (SU-MIMO) and multi-user MIMO (MU-MINO) systems.

It will be understood that while terms such as “first,” “second,” “third,” etc., may be used herein to describe various elements, components, regions, layers, and/or sections, these elements, components, regions, layers, and/or sections should not be limited to these terms. These terms are used only to distinguish one element, component, region, layer, or section from another element, component, region, layer, or partition. Thus, the first element, component, region, layer, or section may be referred to as the second element, component, region, layer, or section without going beyond the scope of the present disclosure. As used herein, the term “and/or” includes any and all combinations of one or more of relevant listed entries. Elements mentioned in the singular do not exclude the plurality of elements, unless otherwise specifically stated.

Functionality of an element specified in the description or claims as a single element may be implemented in practice by multiple components of the device, and conversely, functionality of the elements specified in the description or claims as several separate elements may be implemented in practice by a single component.

Embodiments of the present disclosure are not limited to the embodiments described herein. Other embodiments of the disclosure that do not go beyond the idea and scope of the disclosure will be apparent to a person skilled in the art on the basis of the information provided in the description and prior art knowledge.

Elements mentioned in the singular do not exclude the plurality of elements, unless otherwise specifically stated.

Those skilled in the art will appreciate that the idea of the disclosure is not limited to a particular software or hardware, and therefore any software and hardware known in the art may be used to carry out the disclosure. Thus, the hardware may be implemented in one or more specialized integrated circuits, digital signal processors, digital signal processing devices, programmable logic devices, field-programmable gate arrays, processors, controllers, microcontrollers, microprocessors, electronic devices, other electronic modules configured to perform the functions described herein, a computer, or combinations thereof.

It is apparent that reference to storage of data, programs, etc. implies the provision of a computer-readable data medium. Examples of computer-readable storage media include read-only memory, random access memory, register, cache memory, solid-state storage devices, magnetic media such as internal hard drives and removable disks, magneto-optical media and optical media such as CD-ROM discs and digital universal discs (DVDs), and any other data media known in the art.

Although exemplary embodiments have been described and shown in the accompanying drawings, it should be understood that such embodiments are illustrative only and are not intended to limit the broader disclosure, and that the disclosure should not be limited to the specific layouts and designs shown and described, as various other modifications may be apparent to those skilled in the art.

The features mentioned in various dependent claims as well as the embodiments disclosed in various parts of the specification may be combined to achieve beneficial effects, even if the possibility of such combination is not explicitly disclosed.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of user equipment (UE) for transmitting a sounding reference signal (SRS), the method comprising:
receiving, from a base station (BS), a configuration for a transmission comb-specific SRS sequence;
receiving, from the BS, an indication to transmit an SRS based on the configuration;
generating an SRS based on the configuration;
transmitting, to the BS, the SRS; and
receiving, from the BS, an uplink grant including an indication of precoder based on the SRS,
wherein the SRS is measured to select the precoder.

2. The method of claim 1, wherein the configuration includes a number of SRS ports, SRS transmission comb indexes, and one or more sets of parameters n_{ID}^{λ}^{ₚ}^{,SRS} specific each transmission comb.

3. The method of claim 2, wherein the SRS is transmitted based on a set of parameters n_{ID}^{λ}^{ₚ}^{,SRS} where n_{ID}^{λ}^{ₚ}^{,SRS} value is differently identified for each transmission comb.

4. The method of claim 1, wherein the transmission comb-specific SRS sequence is generated based on:
r̅_{u,v}(n)=x_{q}(n mod N_{ZC}) where
$${x}_{q} ( m ) = \text{?} , q = ⌊ \overline{q} + 1 / 2 ⌋ + {v}_{p} \cdot {( - 1 )}^{⌊ 2 \overline{q} ⌋} ,$$
$$\text{?} \text{indicates text missing or illegible when filed}$$
and q̅=N_{ZC}·(uₚ+1)/31, and where A mod B is an operation of taking a remainder of dividing A by B, x_{q}(m) is a Zadoff-Chu (ZC) sequence, N_{ZC} is a length of the ZC sequence, q is a root of the ZC sequence, q̅ is an intermediate variable, m is a ZC sequence element index, └ ┘ is an operation of rounding a fractional number to a nearest integer that is less than or equal to an original one, n is a running index along a length of SRS sequence, uₚ is a sequence group index for P-th antenna port, vₚ is a base sequence index for P-th antenna port.

5. The method of claim 4, wherein the sequence group index is identified by: uₚ=(f_{gh}(nₛ,l)+n_{ID}^{λ}^{ₚ}^{,SRS})mod 30, where f_{gh}(nₛ,l) is a pseudo-random sequence that depends on a slot index nₛ and an orthogonal frequency division multiplexing (OFDM) symbol index l in a slot, A mod B is an operation of taking a remainder of dividing A by B, n_{ID}^{λ}^{ₚ}^{,SRS} is a transmission comb-specific parameter set for each SRS transmission comb offset λₚ, and λₚ=0, 1, . . . K_{TC}−1, and where K_{TC} is a number of SRS transmission combs.

6. The method of claim 5, wherein a set of comb-specific parameters n_{ID}^{λ}^{ₚ}^{,SRS} ∈{0, 1, . . . , 1023} is configured by a radio resource control (RRC) protocol for each SRS transmission comb offset λₚ.

7. The method of claim 5, wherein a set of comb-specific parameters n_{ID}^{λ}^{ₚ}^{,SRS} is identified based on:
n_{ID}^{λ}^{ₚ}^{,SRS}=n_{ID}^{SRS}+λₚ where n_{ID}^{SRS}∈{0, 1, . . . , 1023} is configured by a radio resource control (RRC) protocol.

8. The method of claim 5, wherein an SRS sequence group hopping is enabled based on:
f_{gh}(nₛ,l)=Σᵢ₌₀⁷c(8(nₛN_{symb}^{slot}+l)+i)2ⁱ mod 30 where nₛ is a slot index, l is an OFDM symbol index in a slot, N_{symb}^{slot} is a number of symbols in a slot, c(·) is a pseudo-random binary sequence initialized with cᵢₙᵢₜ=n_{ID}^{λ}^{ₚ}^{,SRS} or cᵢₙᵢₜ=n_{ID}^{SRS}, i is a binary digit-responsible summation index, A mod B is an operation of taking a remainder of dividing A by B.

9. The method of claim 4, wherein, in case that a base sequence hopping is not enabled, the base sequence index vₚ is determined based on: vₚ=λₚ mod 2 where λₚ is an SRS transmission comb offset, and λₚ=0, 1, . . . K_{TC}−1.

10. The method of claim 4, wherein, in case that a base sequence hopping is enabled, the base sequence index vₚ is determined based on: vₚ=(c(nₛN_{symb}^{slot}+l)+λₚ) mod 2 where λₚ is an SRS transmission comb offset, and λₚ=0, 1, . . . K_{TC}−1, and c(·) is a pseudo-random binary sequence initialized with cᵢₙᵢₜ=n_{ID}^{SRS}.

11. The method of claim 1, wherein the transmission comb-specific SRS sequence is determined by multiple radio resource control (RRC) configuration parameters that are independently configured for each transmission comb.

12. The method of claim 1, wherein the transmission comb-specific SRS sequence is determined by a single SRS parameter and a transmission comb offset.

13. The method of claim 11, wherein the transmission comb-specific SRS sequence corresponds to a sequence group.

14. The method of claim 11, wherein the transmission comb-specific SRS sequence corresponds to a base sequence.

15. The method of claim 1, wherein the transmission comb-specific SRS sequence depends on an orthogonal frequency division multiplexing (OFDM) symbol index in a slot.

16. The method of claim 1, wherein the transmission comb-specific SRS sequence depends on a slot index.

17. The method of claim 14, wherein an actual sequence group index is determined based on the RRC configuration parameters and a pseudo-random sequence.

18. The method of claim 1, wherein multiple comb-specific transmission parameters are configured by a radio resource control (RRC), and an actual set of parameters is indicated by downlink control information (DCI).

19. A user equipment (UE) for transmitting a sounding reference signal (SRS), the UE comprising:
a transceiver configured to:
receive, from a base station (BS), a configuration for a transmission comb-specific SRS sequence, and
receive, from the BS, an indication to transmit an SRS based on the configuration; and
at least one processor operably coupled to the transceiver, the at least one processor configured to generate an SRS based on the configuration,
wherein the transceiver is further configured to:
transmit, to the BS, the SRS, and
receive, from the BS, an uplink grant including an indication of precoder based on the SRS, and
wherein the SRS is measured to select the precoder.

20. A base station (BS) for receiving a sounding reference signal (SRS), the BS comprising:
a processor configured to generate a configuration; and
a transceiver operably coupled to the processor, the transceiver configured to:
transmit, to a user equipment (UE), a configuration for a transmission comb-specific SRS sequence,
transmit, to the UE, an indication to indicate the UE to transmit an SRS based on the configuration,
receive, from the UE, the SRS, and
transmit, to the UE, an uplink grant including an indication of precoder based on the SRS, wherein the SRS is measured to select the precoder.
